(19) United States
(12) Patent Application Publication
(10) Pub. No.: US 2012/0081853 A1
(43) Pub. Date: Apr. 5, 2012

(54) MEDICAL ANTIBACTERIAL FULL-FLAT TOUCH SCREEN

(76) Inventors: Wen-Liang Huang, Hsinchu (TW); Hung-Pin Chen, Hsinchu (TW); Chao-Ming Chiu, Hsinchu (TW); Tsan-Chung Lee, Hsinchu (TW); Jui-Hung Tai, Hsinchu (TW)

(21) Appl. No.: 12/897,899

(22) Filed: Oct. 5, 2010

(51) Int. Cl. G06F 1/16

(52) U.S. Cl. 361/679.21

(57) ABSTRACT

A medical antibacterial full-flat touch screen comprises an antibacterial housing, an antibacterial rubber strip and an antibacterial full-flat panel, wherein a recessed edge is configured around the periphery at the bottom of the antibacterial rubber strip which recessed edge encompassing the periphery of the antibacterial full-flat panel, and a plurality of upright buckle holes are configured on the inner side of the periphery of the antibacterial full-flat panel. In addition, a groove is configured around the periphery at the top of the antibacterial rubber strip such that the antibacterial housing can be directly inserted into the groove, and a plurality of bumps configured on the inner side of the antibacterial housing can be positioned into the upright buckle holes thereby allowing the antibacterial housing and the antibacterial full-flat panel to combine together. Furthermore, the antibacterial rubber strip closely joined between the antibacterial housing and the antibacterial full-flat panel can effectively prevent the breeding of bacteria inside the gap of the assembled body and the infiltration of any liquid into the body as well.

### BACKGROUND OF THE INVENTION

1. Field of the Invention

The present invention relates to a medical antibacterial full-flat touch screen; in particular, the present invention relates to a full-flat touch screen applied in operating rooms, which medical antibacterial full-flat touch screen comprising a number of elements enabling antibacterial functions thereby allowing the medical antibacterial full-flat touch screen used in operating rooms to provide antibacterial and water-proof features.

2. Description of Related Art

Currently well-known concept of antisepsis was developed gradually from the end of 19^{th} century to the beginning of 20^{th} century, mainly in response to the progress in surgical techniques and advancement of medical machineries. The term “Antisepsis” indicates essentially the application of anti-microbial chemical agents on human tissues, while the term “Disinfection” means using such anti-microbial agents on non-living objects. The array of possible medical applications may include hygienic hand washing, pre-surgical preparations of patient's skin, glove wearing in surgical operations, aseptic blanket laying, aseptic isolation measures, machinery sterilization by using autoclave and appropriate disposal of medical wastes etc. Consequently, from medical aspect, it is possible to minimize the chance of hospital-acquired infections by strictly following these concepts and technologies of antisepsis.

The size of an operating room is conventionally required to be at least 20×20 ft² in dimension so as to provide sufficient space for medical personnel to move, to put on aseptic clothes and to lay aseptic blanket on the patient without contaminating the aseptic area. The air in the operating room is filtered through the high efficiency particulate air filter (HEPA filter) which enables removals of germs and moulds in the air. Furthermore, commonly used instruments in the operating room at present are mostly configured with touch screen typed displays so as to facilitate the operators to press down directly on the screen thereby enabling surveillance of patient's biological status and medical equipment operations. However, such electronic instruments are not washable with water, so, upon completing a surgery, the screen of such electronic instruments usually contains blood and a variety of bacteria; without prudent and thorough sterilization processes, it is very likely to place the next patient in an operating environment filled with germs and contaminants In case a doctor makes a direct contact with the touch screen and then performs surgical actions on the patient's body, the potential risk would be impossible to be estimated.

In most cases, tiny gaps may exist on the assembled body of currently available touch screens, thus, after operation, bacteria may be stuck into such small gaps and, for cleansing workers, these small gaps could be very difficult to handle. Hence, in addition to the bacterial issue as previously described, suppose any liquid ever infiltrates into the touch screen during the operation or the cleansing process, the entire touch screen may fail.

As a result, it will be an optimal solution to provide a medical antibacterial full-flat touch screen which is gap-free on the assembled body in order to prevent the breeding of bacteria, allows to block infiltration of any liquid into the body and also enables antibacterial function on the surface of the entire body.

### SUMMARY OF THE INVENTION

An objective of the present invention is to provide a medical antibacterial full-flat touch screen such that, after completing the assembly of the medical antibacterial full-flat touch screen, the existence of the gap on the assembled body can be effectively eliminated thereby preventing the breeding of bacteria in such gaps as in prior art.

Another objective of the present invention is to provide a medical antibacterial full-flat touch screen which can prevent any liquid from infiltrating into the medical antibacterial full-flat touch screen according to the present invention through the gap formed after body assembly.

The medical antibacterial full-flat touch screen according to the present invention comprises an antibacterial housing, an antibacterial rubber strip and an antibacterial full-flat panel, wherein a recessed edge is configured around the periphery at the bottom of the antibacterial rubber strip which recessed edge encompassing the periphery of the antibacterial full-flat panel, and a plurality of upright buckle holes are configured on the inner side of the periphery of the antibacterial full-flat panel. In addition, a groove is configured around the periphery at the top of the antibacterial rubber strip such that the antibacterial housing can be directly inserted into the groove, and a plurality of bumps configured on the inner side of the antibacterial housing can be positioned into the upright buckle holes thereby allowing the antibacterial housing and the antibacterial full-flat panel to combine together. Furthermore, the antibacterial rubber strip closely joined between the antibacterial housing and the antibacterial full-flat panel can effectively prevent the breeding of bacteria inside the gap of the assembled body and the infiltration of any liquid into the body as well.

More specifically, an electronic circuit module is coupled onto the aforementioned antibacterial full-flat panel and the electronic circuit module is configured between the antibacterial full-flat panel and the antibacterial housing.

More specifically, multiple antibacterial layers are coated onto the surface of the aforementioned antibacterial full-flat panel such that the surface of the antibacterial full-flat panel provides the isolation function from a variety of bacteria.

More specifically, multiple antibacterial layers are coated onto the surface of the aforementioned antibacterial housing such that the surface of the antibacterial housing provides the isolation function from a variety of bacteria.

More specifically, the aforementioned antibacterial rubber strip is a strip made of a mixed antibacterial material such that the antibacterial rubber strip provides the isolation function from a variety of bacteria.

### BRIEF DESCRIPTION OF THE DRAWINGS

FIG. 1 shows an integral structural diagram of the medical antibacterial full-flat touch screen according to the present invention;

FIG. 2A shows a front screen view of the medical antibacterial full-flat touch screen according to the present invention;

FIG. 2B shows a rear screen view of the medical antibacterial full-flat touch screen according to the present invention; and

FIG. 3 shows a cross-section view of the medical antibacterial full-flat touch screen according to the present invention.

### DETAILED DESCRIPTION OF THE PREFERRED EMBODIMENTS

The aforementioned and miscellaneous technical contents, features and effects of the present invention can be clearly appreciated through illustrating the following detailed descriptions for preferred embodiments of the present invention with reference to the appended diagrams thereof.

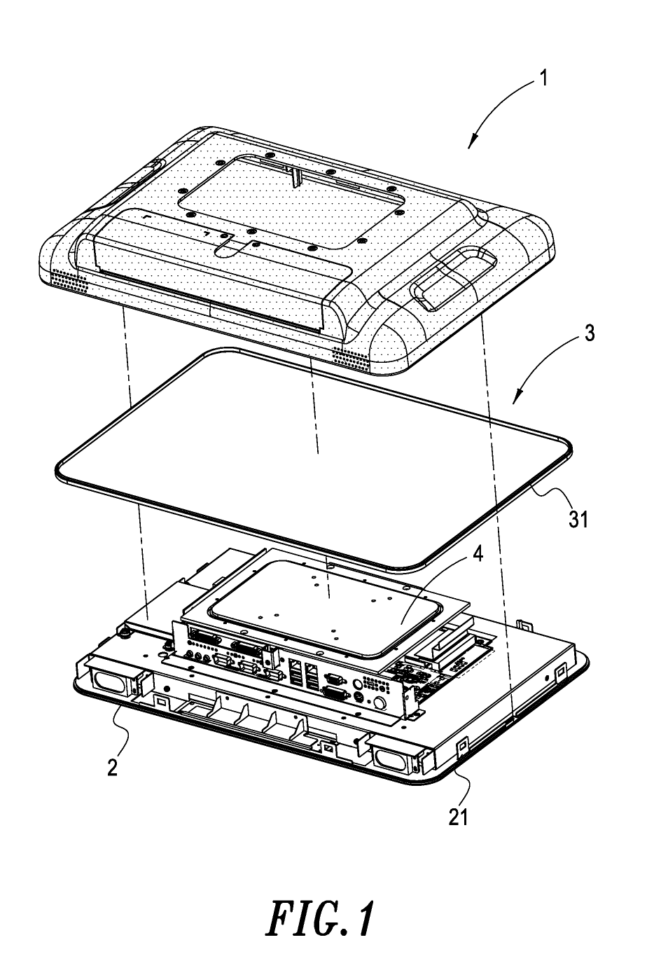

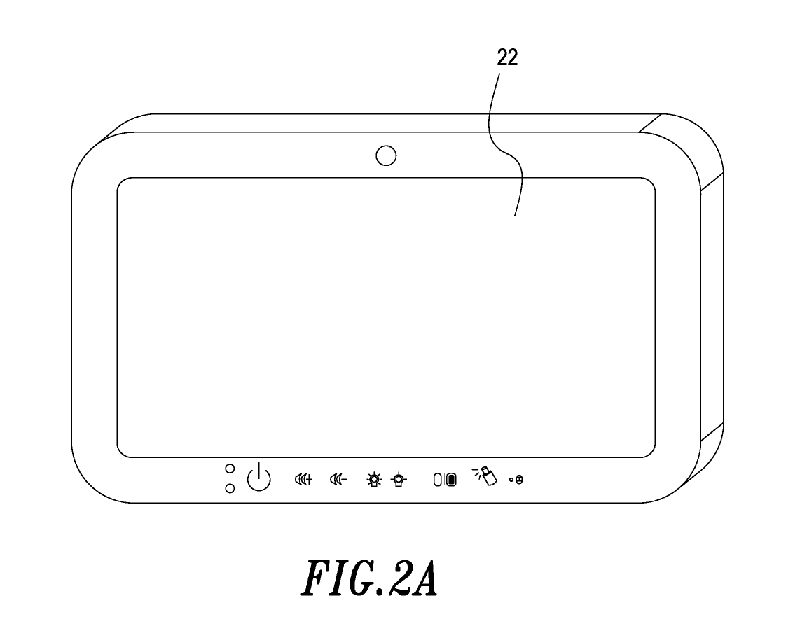

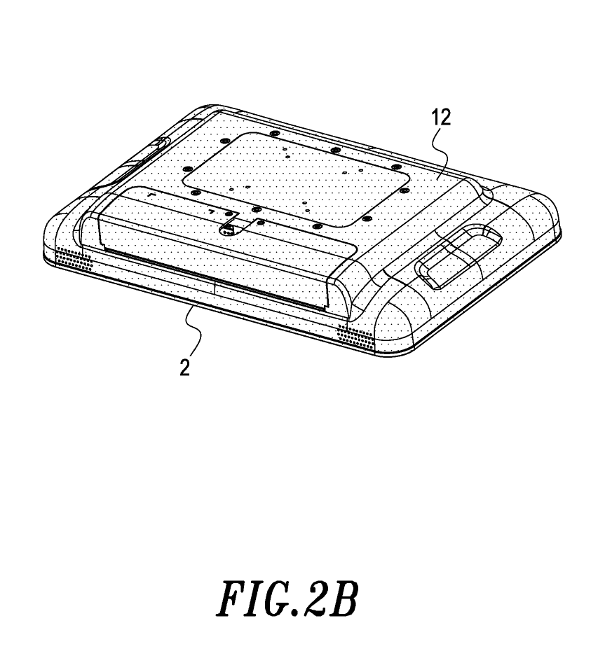

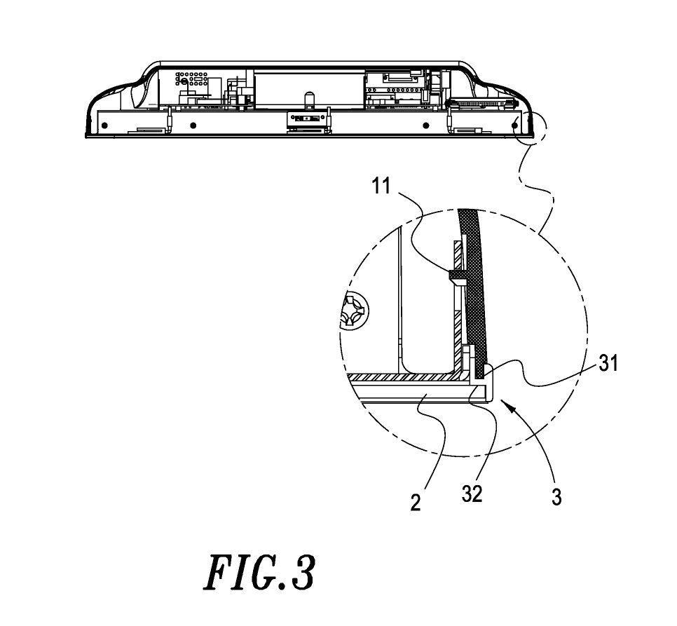

Refer conjunctively to FIGS. 1, 2A, 2B and 3, wherein an integral structural diagram, a front screen view, a rear screen view as well as a cross-section view of the medical antibacterial full-flat touch screen according to the present invention are shown. It can be seen from Figures that the medical antibacterial full-flat touch screen according to the present invention comprises:

an antibacterial housing 1, in which a plurality of bumps 11 are configured on the inner side of the antibacterial housing 1;

an antibacterial full-flat panel 2, in which a plurality of upright buckle holes 21 are configured on the inner side of the periphery of the antibacterial full-flat panel 2, and an electronic circuit module 4 is coupled onto the antibacterial full-flat panel 2;

an antibacterial rubber strip 3, in which a recessed edge 32 is configured around the periphery at the bottom of the antibacterial rubber strip 3 which recessed edge 32 encompassing the periphery of the antibacterial full-flat panel 2, and a groove 31 is also configured around the periphery at the top of the antibacterial rubber strip 3 such that the antibacterial housing 1 can be directly inserted into the groove 31, and the antibacterial rubber strip 3 joined between the antibacterial housing 1 and the antibacterial full-flat panel 2 can effectively prevent the breeding of bacteria inside the gap of the assembled body of the medical antibacterial full-flat touch screen and also enables the medical antibacterial full-flat touch screen to block the infiltration of any liquid into the body.

It should be noticed that the plurality of bumps 11 configured on the inner side of the antibacterial housing 1 can be positioned into the upright buckle holes 21 thereby allowing the antibacterial housing 1 and the antibacterial full-flat panel 2 to combine together.

It should be noticed that the electronic circuit module 4 is configured between the antibacterial housing 1 and the antibacterial full-flat panel 2.

It should be noticed that multiple antibacterial layers are coated onto the surface of the antibacterial full-flat panel 2 such that the surface 22 of the antibacterial full-flat panel provides the isolation function from a variety of bacteria.

It should be noticed that multiple antibacterial layers are coated onto the surface of the antibacterial housing 1 such that the surface 12 of the antibacterial housing provides the isolation function from a variety of bacteria.

It should be noticed that the antibacterial rubber strip 3 is a strip made of a mixed antibacterial material such that the antibacterial rubber strip 3 provides the isolation function from a variety of bacteria.

Compared with other conventional technologies, the medical antibacterial full-flat touch screen according to the present invention provides the following advantages:

1. after completing the assembly of the medical antibacterial full-flat touch screen according to the present invention, the existence of the gap formed by the assembled body can be eliminated thereby preventing the breed of bacteria inside the gap, and the entire body is made of antibacterial materials thereby enabling the isolation function from a variety of bacteria;

2. the objective of the present invention is to provide a medical antibacterial full-flat touch screen which allows to prevent the infiltration of any liquid into the body of the medical antibacterial full-flat touch screen.

Through the aforementioned detailed descriptions of the preferred embodiments according to the present invention, it is intended that the characteristics and features of the present invention can be better illustrated and appreciated, rather than limiting the scope of the present invention by the preferred embodiments disclosed as above. Contrarily, it is desired that all effectively equivalent changes, modifications or substitutions made thereto are encompassed by the scope of the present invention as delineated in the claims set forth hereunder.

What is claimed is:

1. A medical antibacterial full-flat touch screen specifically applied in operating room, which medical antibacterial full-flat touch screen comprising:
an antibacterial housing, in which a plurality of bumps are configured on the inner side of the antibacterial housing;
an antibacterial full-flat panel, in which a plurality of upright buckle holes are configured on the inner side of the periphery of the antibacterial full-flat panel; and
an antibacterial rubber strip, in which a recessed edge is configured around the periphery at the bottom of the antibacterial rubber strip which recessed edge encompassing the periphery of the antibacterial full-flat panel, and a groove is also configured around the periphery at the top of the antibacterial rubber strip such that the antibacterial housing can be directly inserted into the groove.

2. The medical antibacterial full-flat touch screen according to claim 1, wherein an electronic circuit module is coupled onto the antibacterial full-flat panel and the electronic circuit module is configured between the antibacterial full-flat panel and the antibacterial housing.

3. The medical antibacterial full-flat touch screen according to claim 1, wherein the bumps are positioned into the upright buckle holes thereby allowing the antibacterial housing and the antibacterial full-flat panel to combine together.

4. The medical antibacterial full-flat touch screen according to claim 1, wherein multiple antibacterial layers are coated onto the surface of the antibacterial full-flat panel such that the surface of the antibacterial full-flat panel is able to isolate a variety of bacteria.

5. The medical antibacterial full-flat touch screen according to claim 1, wherein multiple antibacterial layers are coated onto the surface of the antibacterial housing such that the surface of the antibacterial housing is able to isolate a variety of bacteria.

6. The medical antibacterial full-flat touch screen according to claim 1, wherein the antibacterial rubber strip is a strip made of a mixed antibacterial material such that the antibacterial rubber strip is able to isolate a variety of bacteria.
